(19) United States
(12) Patent Application Publication
(10) Pub. No.: US 2004/0026839 A1
(43) Pub. Date: Feb. 12, 2004

(54) Spring bushing and method for producing a spring bushing

(76) Inventors: Dietmar Schmieder, Markgroeningen (DE); Uwe Bruetsch, Stuttgart (DE)

Correspondence Address: RONALD E. GREIGG, GREIGG & GREIGG P.L.L.C., 1423 POWHATAN STREET, UNIT ONE, ALEXANDRIA, VA, 22314, US

(21) Appl. No.: 10/634,794

(22) Filed: Aug. 6, 2003

Related U.S. Application Data
(62) Division of application No. 10/219,304, filed on Aug. 16, 2002, now abandoned.

(30) Foreign Application Priority Data
Aug. 16, 2001 (DE) 101 40 197.3

(51) Int. Cl. F16F 1/00

(52) U.S. Cl. 267/150

(57) ABSTRACT

A spring bushing, in particular for prestressing a piezoelectric actuator in a valve for controlling fluids, is disclosed, which is a one-piece deep-drawn part, which is hollow and at least approximately cylindrical. The one-piece body is provided with a number of openings distributed over the circumference and length of the body.

### BACKGROUND OF THE INVENTION

The invention relates to a spring bushing, in particular for prestressing a piezoelectric actuator in a valve for controlling fluids, and a method for producing a spring bushing.

In fuel injection valves with a piezoelectric actuator, in order to trigger the fuel injection valve, a voltage is applied to the piezoelectric actuator, which causes the piezoelectric actuator to rapidly expand due to known physical effects of the piezoceramic, and causes a valve closing member to lift up from a valve seat. The piezoelectric actuator has a certain mass, which is accelerated in this process. If the applied voltage is reduced, the mass of the piezoelectric actuator, due to the acceleration and due to its inertia, still has the tendency to move in the axial expansion direction. Depending on the triggering speed, tensile forces are generated in the piezoelectric actuator, which are due to the acceleration and the withdrawal of the current, and these tensile forces, if they are above certain levels, can cause damage to the piezoelectric actuator. In particular, fractures in the solder connections between the individual layers of the piezoelectric actuator can occur.

In order to prevent such damage, it has become common practice to prestress the piezoelectric actuator in the axial direction by means of a spring bushing. A spring bushing of this kind is described, for example, in DE 38 44 134 A1.

There are spring bushings which are in actual use which are made of a plate-like material. First, a stamping process is used to produce openings in the surface. Then, through rounding, the plate-like form is brought into an approximately cylindrical shape and the two ends of the generated surface are joined at their abutting edges by means of longitudinal welding. Then the two end faces of the hollow cylindrical component are machined to produce a flat contact surface of the spring bushing.

In order to prestress a piezoelectric actuator of a valve for controlling fluids, spring bushings are disposed respectively coaxial to two pistons of a control valve. Between the spring bushing and the pistons, a pressure case is provided in which the two pistons are guided so that they can slide axially. The spring bushings are thus installed between a shoulder of the pressure case and another shoulder that is provided on one of the pistons.

The spring bushings are respectively disposed with their machined end faces against the shoulder of the pressure case and against the other shoulder of the piston; a radial alignment of the spring bushings in a housing of a fuel injection valve is executed by means of a centering collar provided on the outside of the pressure case.

However, these spring bushings known from actual use have the disadvantage that the rigidity of the spring bushings is reduced by the longitudinal welding seam that each one possesses. Consequently, spring bushings that are welded in this manner have a low strength and can possibly buckle or bulge in the region of the welded seam during operation of a fuel injection valve.

The axial forces, which are required for prestressing the piezoelectric actuator and therefore act on the spring bushing, can be exerted without a deformation of the spring bushing by increasing the wall thickness or the sheet metal thickness of the spring bushings. This measure, however, has the disadvantageous result that, due to the limited radial space in the control valve housing, the wall thickness of the pressure case must be reduced. This can lead to an expansion of the pressure case under the high operating pressures that occur in the fuel injection valve during operation. Such an expansion leads to an undesirably high leakage flow from a hydraulic chamber disposed between the pistons in the control valve.

It is also disadvantageous that the dual-ended axial machining of the spring bushings incurs high production costs. In addition, the rounding is only able to achieve an approximately cylindrical form of the spring bushing, because the initially plate-shaped generated surface with the interstices between the openings cannot be brought into the desired perfectly round, or cylindrical, shape during the rounding, due to its lack of homogeneity. Instead, the final shape resembles a polygon, which takes up considerably more space in the housing of the fuel injection valve.

### OBJECT AND SUMMARY OF THE INVENTION

The spring bushing according to this invention has the advantage over the prior art that it can be embodied as a hollow cylindrical body with a favorable degree of roundness. It therefore takes up only a small amount of space. It is also advantageous that the wall thickness of the spring bushing can be reduced in comparison to that of welded spring bushings previously known. Even though thinner, it can be subjected to the same level of load without deformation of the spring bushing.

This is achieved by virtue of the fact that the spring bushing is embodied as a one-piece deep-drawn part, which is produced without a longitudinal welding seam that would disadvantageously lead to a bulging of the spring bushing with the same wall thickness and a high load.

Reducing the wall thickness of the spring bushing achieves the advantage that its reduced space requirement permits an increase in the wall thickness of the pressure case of a fuel injection valve. This leads to a minimization of a leakage flow from a hydraulic chamber, which is provided in a known manner to allow for a longitudinal compensation in the fuel injection valve.

The method for producing a spring bushing according to this invention has the advantage over the prior art that it produces a spring bushing which has a high strength while requiring little space, and can be produced in a simple, inexpensive manner.

The spring bushing is embodied as an at least approximately hollow, cylindrical, one-piece body by means of deep drawing, and then a number of openings are formed into the generated surface, which openings are distributed evenly over the circumference and the length of the body. This produces a spring bushing which has a high strength and a low wall thickness, and the spring bushing has a favorable degree of roundness. This advantageously reduces the space required.

The method according to this invention also offers the advantage that cost-intensive subsequent machining steps are not required to produce a spring bushing.

The invention will be better understood and further objects and advantages thereof will become more apparent from the ensuing detailed description of preferred embodiments taken in conjunction with the drawings.

### BRIEF DESCRIPTION OF THE DRAWINGS

FIG. 1 shows a schematic, detailed depiction of a first exemplary embodiment of the spring bushing according to the invention, which is provided in a fuel injection valve for internal combustion engines,

FIG. 2 shows an embodiment of the spring bushing by itself,

FIG. 3 shows a longitudinal section through the spring bushing along the line III-III in FIG. 2, and

FIG. 4 shows a schematic, illustration of the spring bushing depicted in FIGS. 2 and 3, which is provided in a control valve.

### DESCRIPTION OF THE PREFERRED EMBODIMENTS

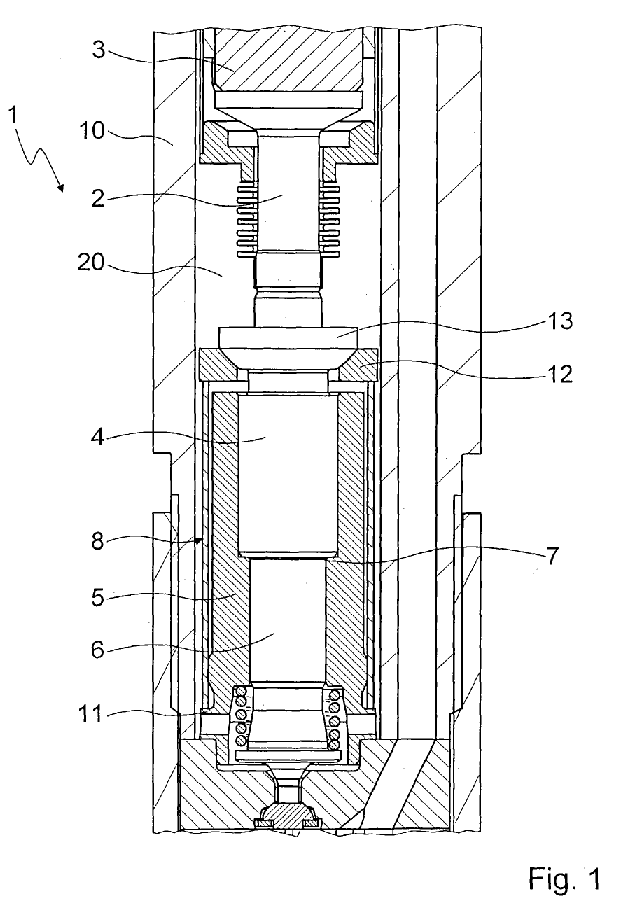

The exemplary embodiment shown in FIG. 1 shows a spring bushing 8 according to the invention in a valve for controlling fluids or a fuel injection valve 1 for internal combustion engines of motor vehicles. In this embodiment, the fuel injection valve 1 is embodied as a common rail injector for injecting diesel fuel.

In order to adjust the injection onset, the injection duration, and the injection quantity by means of force ratios in the fuel injection valve 1, an actuator foot 2 is triggered by means of a piezoelectric unit embodied as a piezoelectric actuator 3, which is disposed at an end of the actuator foot 2 oriented away from the valve control chamber and combustion chamber. As usual, the piezoelectric actuator 3 used is comprised of a number of piezoceramic layers.

At the end of the actuator foot 2 oriented away from the piezoelectric actuator 3, there is an upper, first piston 4, which is disposed in a pressure case 5 and is adjoined by a lower, second piston 6, which is guided so that it can move axially, also in the pressure case 5.

The pistons 4 and 6 are coupled to each other by means of a hydraulic transmission. The hydraulic transmission is embodied as a hydraulic chamber 7, which transmits the deflection of the piezoelectric actuator 3 and the first piston 4 to the second piston 6. Between the two pistons 4 and 6, of which second piston 6 has a smaller diameter than the first piston 4, the hydraulic chamber 7 encloses a shared compensation volume in which a system pressure P_{sys} prevails. The hydraulic chamber 7 is enclosed between the pistons 4 and 6 in such a way that the second piston 6 executes a stroke that is increased by the transmission ratio of the piston diameters, when the piezoelectric actuator 3 moves the larger first piston 4 by a particular distance. The piezoelectric actuator 3, the actuator foot 2, and the pistons 4 and 6 are disposed one after another on a common axis.

The compensation volume of the hydraulic chamber 7 can be used to compensate for tolerances due to temperature gradients in the fuel injection valve 1 or different thermal expansion coefficients of the materials used, as well as possible settling effects, without thereby changing the position of a fuel injection valve 1 closing member that is to be controlled.

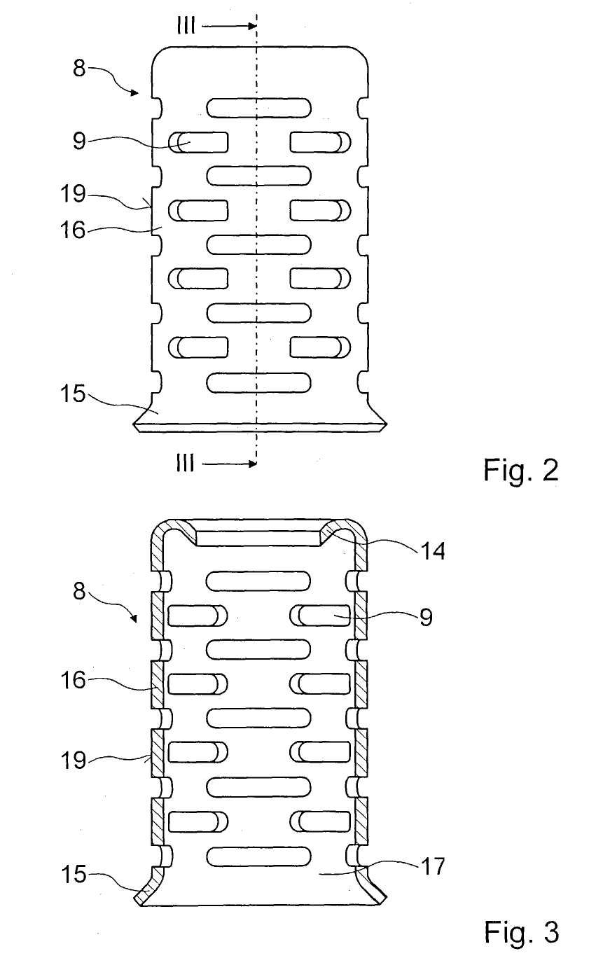

In order to prestress the piezoelectric actuator 3, a spring bushing 8 comprised of a hollow cylindrical body is provided, which has a number of openings 9 distributed over the circumference and length of the spring bushing that are shown in detail in FIG. 2. The spring bushing 8 is embodied as a one-piece deep-drawn part, which is made from a plate-like metallic work piece; the openings 9 are stamped out from the cylindrical body after the deep drawing. The deep drawing lends the spring bushing 8 a high degree of roundness, which permits it to be easily installed coaxially within the pressure case 5 in a housing 10 of the fuel injection valve 1, and means that it only requires a small amount of space.

It is naturally left to the discretion of the person skilled in the art whether, in lieu of a stamping process, to use another suitable manufacturing process to produce the openings 9 in the hollow cylindrical body of the spring bushing 8, for example laser welding, drilling, or a combination of suitable manufacturing processes.

According to the exemplary embodiment in FIG. 1, the spring bushing 8 is installed between a collar 11 of the pressure case 5 and an adjusting piece 12; this adjusting piece 12 is supported on an annular shoulder piece 13 of the first piston 4. The contact surfaces of the collar 11 and of the adjusting piece 12 are embodied perpendicular to the symmetry axis of the spring bushing 8.

Due to the small amount of space required by the spring bushing 8, a wall thickness of the pressure case 5 in the region of the first piston 4 can be embodied as greater than is the case in the welded spring bushings known from the prior art. The increased wall thickness of the pressure case 5 in the region of the first piston 4 means that the operating pressures prevailing during operation of the fuel injection valve 1 result in a reduced expansion of the pressure case 5 so that a leakage flow from the hydraulic chamber 7 between the pressure case 5 and the first piston 4 into an inner chamber 20 of the fuel injection valve 1 is minimized.

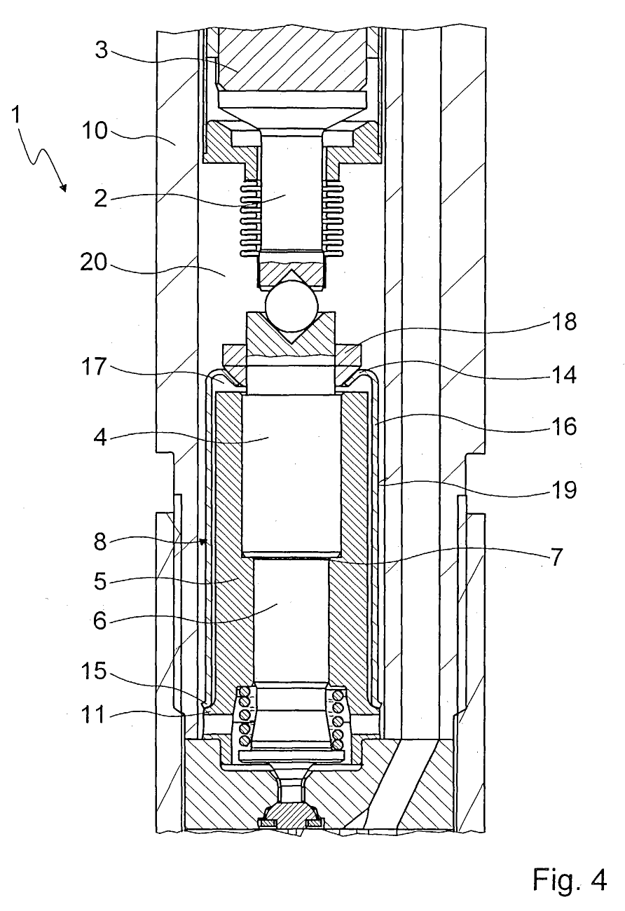

A particularly advantageous embodiment of the spring bushing 8 is shown in FIGS. 2 and 3, and FIG. 4 shows this embodiment installed in a fuel injection valve 1 that essentially corresponds to the structure shown in FIG. 1, has a first centering collar 14 and a second centering collar 15, which are preferably embodied in the form of truncated cones, at its two ends.

The first centering collar 14 adjoins a cylindrical middle part 16 of the spring bushing 8 and is essentially disposed in an inner chamber 17 of the spring bushing 8. In addition, the first centering collar 14 rests against an adjusting element 18, which is slid over the first piston 4 during installation and is welded to the first piston 4, with the spring bushing 8 in a prestressed state.

The second centering collar 15 adjoins the middle part 16 like a funnel and protrudes beyond the outside 19 of the spring bushing 8 at its middle part 16. The spring bushing 8 is supported with the second centering collar 15 against the annular collar 11 of the pressure case 5. The two centering collars 14, 15 and are provided for aligning the spring bushing 8 both in the housing 10 of the fuel injection valve 1 and in relation to the pressure case 5; a contact surface of the collar 11 of the pressure case 5 oriented toward the spring bushing 8 and a contact surface of the adjusting element 18 on the first piston 4 each have a spherical curvature oriented toward the spring bushing 8, which permits a simple and effective centering of the spring bushing 8 in relation to the pressure case 5 and the two pistons 4, 6.

The two centering collars 14, 15 are simply manufactured together with the hollow cylindrical middle part 16 of the spring bushing 8 in a single manufacturing step during the deep drawing, so that it is not necessary to machine the contact surfaces of the spring bushing 8 oriented toward the adjusting element 18 and the collar 11 of the pressure case 5. This considerably reduces the manufacturing costs of the spring bushing 8.

Another improvement in the function of the spring bushing 8 is achieved if a metallic material with a high carbon content is used for the production of the spring bushing. This advantageously provides a ductile material for the deep drawing process, which after the production of the desired shape of the spring bushing 8, is subjected to a hardening and tempering process in order to increase the strength of the spring bushing 8 in accordance with the given requirements.

The foregoing relates to preferred exemplary embodiments of the invention, it being understood that other variants and embodiments thereof are possible within the spirit and scope of the invention, the latter being defined by the appended claims.

We claim:

1. A spring bushing, in particular for prestressing a piezoelectric actuator (3) in a valve (1) for controlling fluids, which spring bushing is a hollow, approximately cylindrical body and is provided with a number of openings (9) distributed over its circumference and length, characterized in that the spring bushing is embodied as a one-piece deep-drawn part (8).

2. The spring bushing according to claim 1, characterized in that a first centering collar (14) is provided on at least one end of the one-piece part (8).

3. The spring bushing according to claim 2, characterized in that the first centering collar (14) is embodied in the form of a truncated cone.

4. The spring bushing according to claim 2, characterized in that the first centering collar (14) adjoins a cylindrical middle part (16) and is disposed in an inner chamber (17) of the one-piece part (8).

5. The spring bushing according to claim 3, characterized in that the first centering collar (14) adjoins a cylindrical middle part (16) and is disposed in an inner chamber (17) of the one-piece part (8).

6. The spring bushing according to claim 2, characterized in that the one-piece part (8) includes a second centering collar (15) in the form of a truncated cone, which is disposed at an end of the one-piece part (8) remote from the end provided with the first centering collar (14).

7. The spring bushing according to claim 3, characterized in that the one-piece part (8) includes a second centering collar (15) in the form of a truncated cone, which is disposed at an end of the one-piece part (8) remote from the end provided with the first centering collar (14).

8. The spring bushing according to claim 4, characterized in that the one-piece part (8) includes a second centering collar (15) in the form of a truncated cone, which is disposed at an end of the one-piece part (8) remote from the end provided with the first centering collar (14).

9. The spring bushing according to claim 6, characterized in that the second centering collar (15) protrudes beyond an outside (19) of the cylindrical middle part (16) and adjoins the middle part (16) like a funnel.

10. The spring bushing according to claim 7, characterized in that the second centering collar (15) protrudes beyond an outside (19) of the cylindrical middle part (16) and adjoins the middle part (16) like a funnel.

11. The spring bushing according to claim 8, characterized in that the second centering collar (15) protrudes beyond an outside (19) of the cylindrical middle part (16) and adjoins the middle part (16) like a funnel.

12. A method for producing a spring bushing according to claim 1, characterized in that the hollow, approximately cylindrical, one-piece part (8) is formed by deep drawing and then a number of openings (9) are formed in it, which openings (9) are distributed over the circumference and length of the one-piece part (8).

13. The method according to claim 12, characterized in that the openings (9) are produced by means of stamping.

14. The method according to claim 13, characterized in that the openings (9) are produced by means of laser welding.

15. The method according to claim 12, characterized in that the one-piece part (8) is hardened and tempered.

16. The method according to claim 13, characterized in that the one-piece part (8) is hardened and tempered.

17. The method according to claim 14, characterized in that the one-piece part (8) is hardened and tempered.
